(19) United States
(12) Patent Application Publication
(10) Pub. No.: US 2025/0226167 A1
(43) Pub. Date: Jul. 10, 2025

(54) ELECTROMAGNETIC RELAY

(71) Applicant: OMRON Corporation, Kyoto-shi, Kyoto (JP)

(72) Inventors: Ayata HORIE, Kyoto-shi, Kyoto (JP); Hiroyuki IWASAKA, Kyoto-shi, Kyoto (JP); Ryota MINOWA, Kyoto-shi, Kyoto (JP); Shinichi OGAWA, Kyoto-shi, Kyoto (JP); Kohei OTSUKA, Kyoto-shi, Kyoto (JP)

(21) Appl. No.: 18/844,976

(22) PCT Filed: Jan. 16, 2023
(86) PCT No.: PCT/JP2023/000914

§ 371 Date: Sep. 9, 2024

(30) Foreign Application Priority Data
Mar. 31, 2022 (JP) 2022-060448

(51) Int. Cl. H01H 50/36; H01H 50/02; H01H 50/14; H01H 50/54

(52) U.S. Cl. CPC H01H 50/36; H01H 50/02; H01H 50/14; H01H 50/54

(57) ABSTRACT

An electromagnetic relay includes a first fixed terminal including a first fixed contact, a movable contact piece, a housing, a magnet, and a yoke. The movable contact piece includes a first movable contact. The housing accommodates the first fixed contact and the movable contact piece. The magnet includes a first magnetic surface directed in a first direction, a second magnetic surface directed in a second direction perpendicular to the first direction, and a third magnetic surface directed in a third direction perpendicular to the first and second directions. The yoke is connected to the magnet and includes a first portion disposed opposite to the first magnetic surface and attracted to the first magnetic surface; a second portion disposed opposite to the second magnetic surface and attracted to the second magnetic surface; and a third portion disposed opposite to the third magnetic surface and attracted to the third magnetic surface.

### CROSS-REFERENCE TO RELATED APPLICATION

This application is the U.S. National Phase of International Application No. PCT/JP2023/000914, filed on Jan. 16, 2023. That application claims priority to Japanese Patent Application No. 2022-060448, filed Mar. 31, 2022. The contents of those two applications are incorporated by reference herein in their entireties.

### FIELD

The claimed invention relates to an electromagnetic relay.

### BACKGROUND

Conventionally, electromagnetic relays have been known in which arcs are generated at the contacts, extended by the magnetic force of a magnet, and then extinguished. The magnet is approximately rectangular in shape and is connected to a yoke. The yoke, together with the magnet, forms a magnetic circuit. The yoke is attracted to the magnet in two axial directions, that is, a first direction and a second direction perpendicular to the first direction. See, for instance, Japanese Patent Application Publication No. 2012-104366.

In the conventional electromagnetic relays, the magnet does not exert a magnetic force on the yoke in the third orthogonal direction, which is perpendicular to the first direction and the second direction. If the magnet is not fixed to a contact case or the like, the magnet may move in the third direction upon an impact applied to the electromagnetic relay, which may adversely affect the operation of the electromagnetic relay.

### SUMMARY

An objective of the claimed invention is to provide an electromagnetic relay in which a magnet is unlikely to move relative to a yoke.

An electromagnetic relay according to one aspect of the claimed invention includes a first fixed terminal, a movable contact piece, a housing, a magnet, and a yoke. The first fixed terminal includes a first fixed contact. The movable contact piece includes a first movable contact disposed opposite to the first fixed contact. The housing accommodates the first fixed contact and the movable contact piece. The magnet generates a magnetic field inside the housing. The magnet includes a first magnetic surface directed in a first direction, a second magnetic surface directed in a second direction perpendicular to the first direction, and a third magnetic surface directed in a third direction perpendicular to the first direction and the second direction. The yoke is connected to the magnet. The yoke includes a first portion, a second portion, and a third portion. The first portion is disposed opposite to the first magnetic surface and is attracted to the first magnetic surface. The second portion is disposed opposite to the second magnetic surface and is attracted to the second magnetic surface. The third portion is disposed opposite to the third magnetic surface and is attracted to the third magnetic surface.

In the electromagnetic relay, the magnetic force of the magnet acts on the yoke in the first direction, the second direction, and the third direction. That is, the magnetic force of the magnet acts on the yoke in three mutually orthogonal axial directions. With this configuration, the yoke makes the magnet unlikely to move in the three axial directions relative to the yoke. Compared to the case where the magnet is fixed by a seal member, for example, the movement of the magnet in the three axial directions can be decreased with a simple configuration, and there will be no increase in the manufacturing cost of the electromagnetic relay. Furthermore, the modified shape of the yoke can restrict the movement of the magnet in the three axial directions, thereby maintaining the arrangement and size of the magnet. As a result, the interruption performance for arcs can be preserved. Additionally, the magnetic flux leakage of the magnet can be reduced in the three axial directions.

The first fixed contact may be disposed opposite to the first movable contact in the third direction. The third portion of the yoke may be disposed in contact with the third magnetic surface. In this case, the magnet is further restricted from moving in the third direction relative to the yoke.

At least one of the first and second portions of the yoke may be disposed in contact with the magnet. In this case, the magnet is further restricted from moving in at least one of the first and second directions relative to the yoke.

The first fixed contact may be disposed opposite to the first movable contact in the third direction. The yoke may be restricted from moving in the third direction relative to the housing. In this case, the magnet is further restricted from moving in the third direction.

The third magnetic surface of the magnet may be directed in a direction extending from the first fixed contact toward the first movable contact. In this case, upon application of an impact to the electromagnetic relay in a direction extending from the first movable contact toward the first fixed contact, the magnet moves less in the direction from the first movable contact toward the first fixed contact, which results in fewer adverse effects on the members disposed around the magnet.

The first fixed contact may be disposed opposite to the first movable contact in the third direction. The magnet may overlap the first fixed terminal as viewed in the third direction. In this case, in the electromagnetic relay in which the magnet overlaps the first fixed terminal as viewed in the third direction, the magnet is restricted from moving relative to the yoke in three axial directions. In addition, upon application of an impact to the electromagnetic relay, the magnet moves less in the third direction, which results in fewer adverse effects on the first fixed terminal.

The magnet may be disposed between the first fixed terminal and the third portion of the yoke in the third direction. In this case also, in the electromagnetic relay in which the magnet overlaps with the first fixed terminal as viewed in the third direction, the magnet is restricted from moving in the three axial directions relative to the yoke.

The electromagnetic relay may further include a second fixed terminal disposed apart from the first fixed terminal in the second direction. The second fixed terminal may include a second fixed contact. The movable contact piece may include a second movable contact disposed opposite to the second fixed contact in the third direction. The third portion of the yoke may have a dimension, in the second direction, that is one-fifth or more of the dimension of the third magnetic surface of the magnet in the second direction. In this case, the area of the third portion of the yoke is increased, and the magnetic force of the magnet acting on the third portion is increased. This configuration further restricts the magnet from moving in the third direction relative to the yoke.

### BRIEF DESCRIPTION OF THE DRAWINGS

FIG. 1 is a cross-sectional view of an electromagnetic relay in accordance with the claimed invention.

FIG. 2 is a perspective view of a contact case used in the electromagnetic relay illustrated in FIG. 1, and the surrounding portions.

FIG. 3 is a front view of the contact case illustrated in FIG. 2, and the surrounding portions.

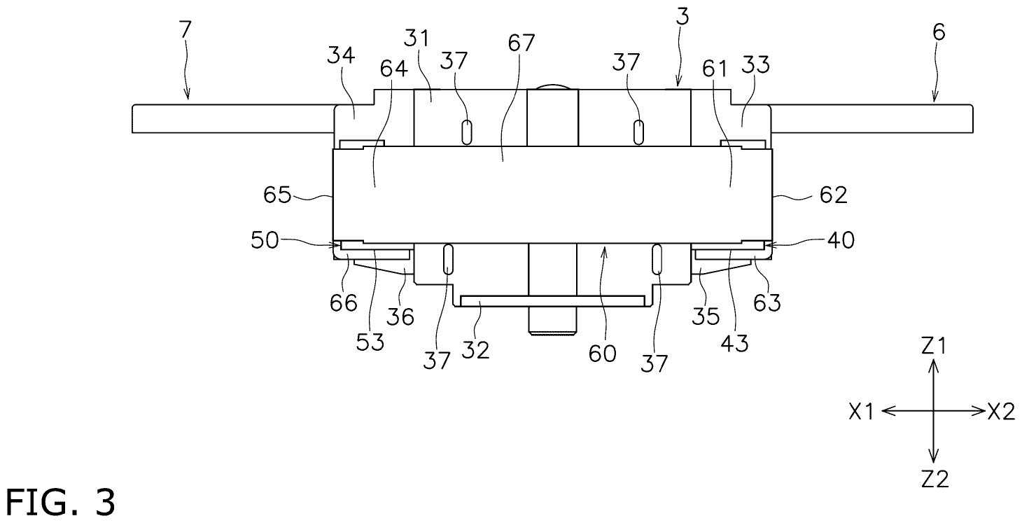

FIG. 4 is a bottom view of the contact case illustrated in FIG. 2, and the surrounding portions.

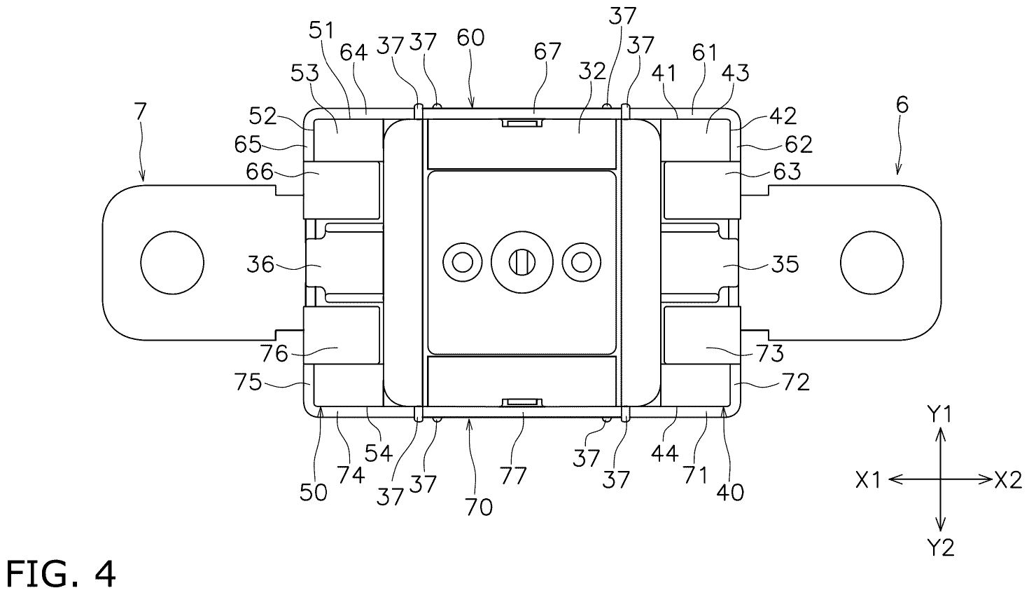

### DETAILED DESCRIPTION

Hereinafter, an embodiment of an electromagnetic relay 100 according to one aspect of the claimed invention will be described with reference to the drawings. It should be noted that, when referring to the drawings, the X1 direction will be described as the left direction, the X2 direction as the right direction, the Y1 direction as the forward direction, the Y2 direction as the rearward direction, the Z1 direction as the upward direction, and the Z2 direction as the downward direction. Also, the X1 and X2 directions will be described as the left-right direction (an example of the second direction), the Y1 and Y2 directions as the forward-backward direction (an example of the first direction), and the Z1 and Z2 directions as the upward-downward direction (an example of the third direction). These directions are defined for the convenience of description and do not limit the arrangement directions of the electromagnetic relay 100.

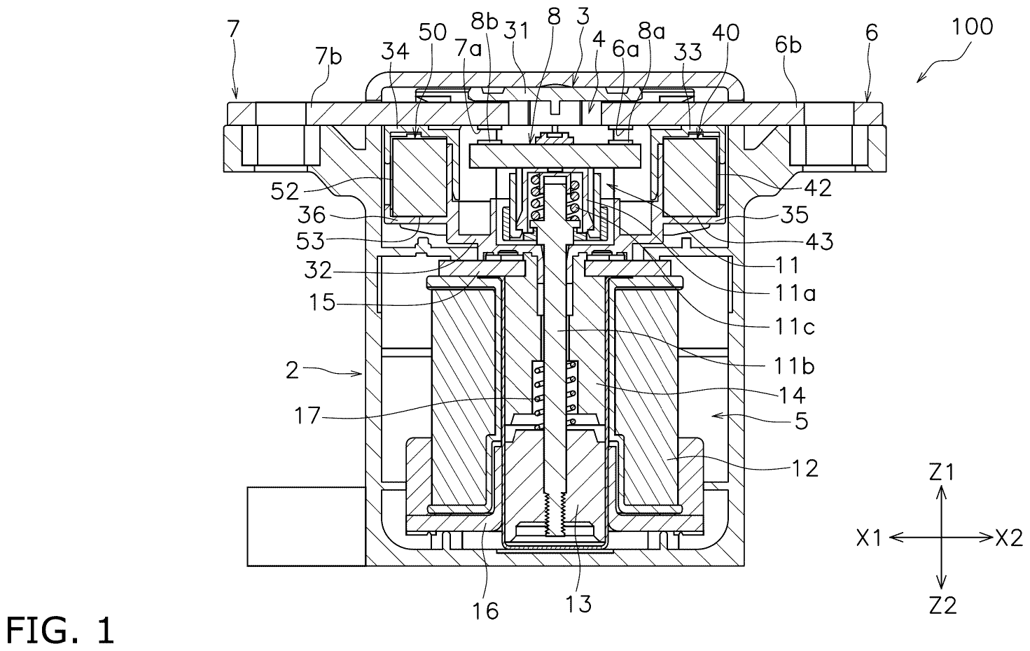

As illustrated in FIG. 1, the electromagnetic relay 100 includes a case 2, a contact case 3, a contact device 4, and a drive device 5.

The case 2 is substantially rectangular box-shaped and is comprised of insulating material such as resin. The case 2 houses the contact case 3, the contact device 4, and the drive device 5.

The contact case 3 is an example of a housing. The contact case 3 is disposed inside the case 2. The contact case 3 is disposed above the drive device 5. The contact case 3 is substantially rectangular box-shaped and is comprised of insulating material such as resin.

The contact case 3 includes an upper case 31, a lower case 32, a first terminal support 33, a second terminal support 34, a first magnet support 35, and a second magnet support 36. The upper case 31 opens downwardly. The upper case 31 is disposed above the lower case 32. The upper case 31 is a separate member from the lower case 32. The upper case 31 is fixed to the lower case 32 by, for example, a snap-fit connection. The lower case 32 opens upwardly. The lower case 32 is covered, at the top, by the upper case 31, which closes both the upper case 31 and the lower case 32.

The first terminal support 33 and the second terminal support 34 are located on the upper case 31. The first terminal support 33 protrudes to the right from the upper case 31. The first terminal support 33 is open to the right. The second terminal support 34 protrudes to the left from the upper case 31. The second terminal support 34 is open to the left.

The first magnet support 35 and the second magnet support 36 are formed on the lower case 32. The first magnet support 35 protrudes to the right from the lower case 32. The first magnet support 35 is disposed below the first terminal support 33. The second magnet support 36 protrudes to the left from the lower case 32. The second magnet support 36 is disposed below the second terminal support 34.

The contact device 4 includes a first fixed terminal 6, a second fixed terminal 7, and a movable contact piece 8.

The first fixed terminal 6 and the second fixed terminal 7 are plate terminals comprised of conductive material. The first fixed terminal 6 and the second fixed terminal 7 extend in the left-right direction. The first fixed terminal 6 and the second fixed terminal 7 extend from the inside of the contact case 3 to the outside. The first fixed terminal 6 and the second fixed terminal 7 are spaced apart from each other in the left-right direction. The first fixed terminal 6 and the second fixed terminal 7 are fixed to the upper case 31 of the contact case 3.

The first fixed terminal 6 is fixedly press-fitted to the first terminal support 33. The first fixed terminal 6 includes a first fixed contact 6a and a first external connection 6b. The first fixed contact 6a is accommodated in the contact case 3. The first fixed contact 6a is disposed opposite to the movable contact piece 8 in the up-down direction. The first fixed contact 6a is disposed on the lower surface of the first fixed terminal 6. The first external connection 6b is disposed outside the case 2. The first external connection 6b is to be connected to an external terminal (not shown), such as a bus bar.

The second fixed terminal 7 is fixedly press-fitted to the second terminal support 34. The second fixed terminal 7 has a shape symmetrical to the first fixed terminal 6. The second fixed terminal 7 is disposed to the left of the first fixed terminal 6. The second fixed terminal 7 includes a second fixed contact 7a and a second external connection 7b. The second fixed contact 7a is accommodated in the contact case 3. The second fixed contact 7a faces the movable contact piece 8 in the up-down direction. The second fixed contact 7a is disposed on the lower surface of the second fixed terminal 7. The second external connection 7b is disposed outside the case 2. The second external connection 7b is to be connected to an external terminal (not shown) such as a bus bar.

The movable contact piece 8 is accommodated in the contact case 3. The movable contact piece 8 is a plate terminal that is elongated in one direction and is comprised of conductive material. The movable contact piece 8 extends in the left-right direction. The movable contact piece 8 is movable in the up-down direction.

The movable contact piece 8 includes a first movable contact 8a and a second movable contact 8b. The first movable contact 8a and the second movable contact 8b are disposed on the upper surface of the movable contact piece 8. The first movable contact 8a is disposed opposite to the first fixed contact 6a in the up-down direction. The second movable contact 8b is disposed opposite to the second fixed contact 7a in the up-down direction.

The drive device 5 is disposed inside the case 2. The drive device 5 moves the movable contact piece 8 in the up-down direction. The drive device 5 includes a movable mechanism 11, a coil 12, a movable iron core 13, a fixed iron core 14, yokes 15 and 16, and a return spring 17.

The movable mechanism 11 is connected to the movable contact piece 8. The movable mechanism 11 includes a holder 11a, a drive shaft 11b, and a contact spring 11c. The holder 11a holds the movable contact piece 8. The holder 11a moves integrally with the movable contact piece 8. The drive shaft 11b extends in the up-down direction. The drive shaft 11b is connected to the holder 11a so as to be movable relative to the holder 11a in the up-down direction. The contact spring 11c is disposed between the holder 11a and the drive shaft 11b. The contact spring 11c biases the movable contact piece 8 upward via the holder 11a.

When excited by the application of a voltage, the coil 12 generates an electromagnetic force which causes the movable iron core 13 to move upward. The movable iron core 13 is fixed to the drive shaft 11b so as to be integrally movable therewith. The fixed iron core 14 is disposed above the movable iron core 13 to face the movable iron core 13. The yokes 15 and 16 are disposed so as to surround the coil 12. The yoke 15 has a substantial U-shape and is connected to the fixed iron core 14. The yoke 16 is disposed below the coil 12 to be connected to the yoke 15. The return spring 17 biases the movable iron core 13 downward.

The operation of the electromagnetic relay 100 is the same as that of conventional relays and will be described here briefly. FIG. 1 shows a state in which the coil 12 is not excited. In this state, the first movable contact 8a is separated from the first fixed contact 6a, and the second movable contact 8b is separated from the second fixed contact 7a. When the coil 12 is excited, the movable iron core 13 is attracted to the fixed iron core 14 and moves upward together with the drive shaft 11b. As the drive shaft 11b moves, the movable contact piece 8 moves upward via the contact spring 11c, so that the first movable contact 8a comes into contact with the first fixed contact 6a, and the second movable contact 8b comes into contact with the second fixed contact 7a. When the application of voltage to the coil 12 is stopped, the drive shaft 11b moves downward together with the movable iron core 13 due to the biasing force of the return spring 17. This causes the movable contact piece 8 to move downward, the first movable contact 8a to move away from the first fixed contact 6a, and the second movable contact 8b to move away from the second fixed contact 7a.

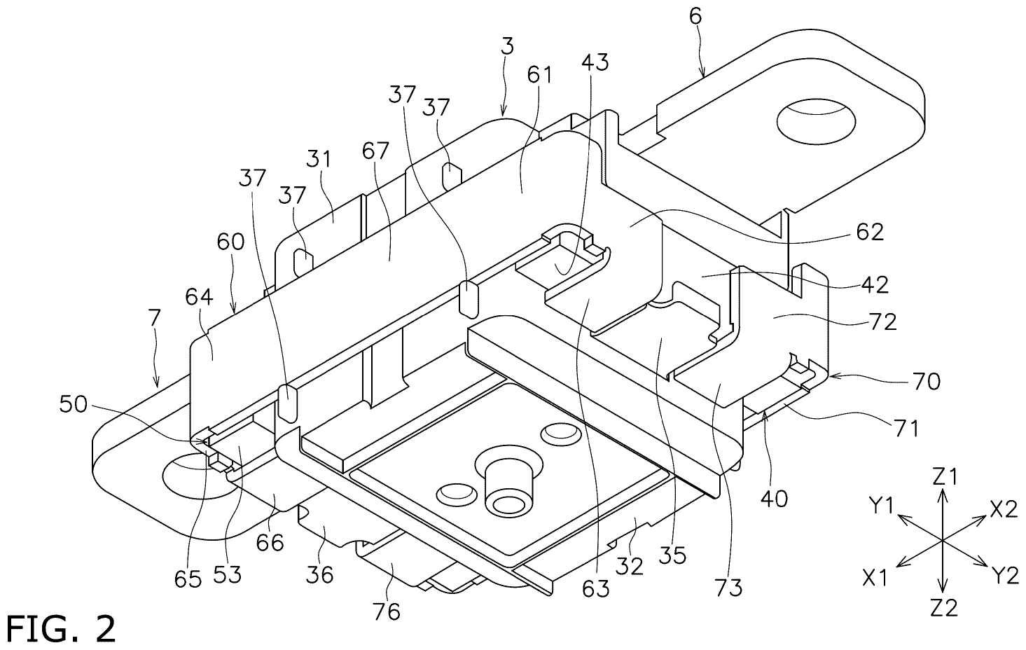

As illustrated in FIGS. 1 and 2, the electromagnetic relay further includes a first magnet 40, a second magnet 50, a first yoke 60, and a second yoke 70.

The first magnet 40 and the second magnet 50 generate a magnetic field inside the contact case 3. The first magnet 40 and the second magnet 50 are permanent magnets of a rectangular parallelepiped shape. The first magnet 40 and the second magnet 50 are disposed around the contact case 3. The first magnet 40 and the second magnet 50 are held by the first yoke 60 and the second yoke 70.

The first magnet 40 is disposed to the right side of the contact case 3. The first magnet 40 is disposed between the first terminal support 33 and the first magnet support 35. The first magnet 40 is placed on the first magnet support 35. When the downward direction in FIG. 1 corresponds to the direction of gravity, the first magnet 40 is drops slightly away from the first terminal support 33 in the up-down direction. In other words, the first magnet 40 is not immovably fixed to the contact case 3. The first magnet 40 overlaps with the first fixed terminal 6 as viewed in the up-down direction. The first magnet 40 is disposed below the first fixed terminal 6.

The first magnet 40 includes a first magnetic surface 41, a second magnetic surface 42, a third magnetic surface 43, and a fourth magnetic surface 44. The first magnetic surface 41 faces in the front-rear direction. In the present embodiment, the first magnetic surface 41 is the front surface of the first magnet 40. The second magnetic surface 42 faces in the left-right direction. In the present embodiment, the second magnetic surface 42 is the right surface of the first magnet 40. The third magnetic surface 43 faces in the up-down direction. In this embodiment, the third magnetic surface 43 is the bottom surface of the first magnet 40. The fourth magnetic surface 44 faces in the front-rear direction. In the present embodiment, the fourth magnetic surface 44 is the rear surface of the first magnet 40.

The second magnet 50 is disposed to the left side of the contact case 3. The second magnet 50 is disposed so as to face the first magnet 40 in the left-right direction. The second magnet 50 is disposed between the second terminal support 34 and the second magnet support 36. The second magnet 50 is placed on the second magnet support 36. When the downward direction in FIG. 1 corresponds to the direction of gravity, the second magnet 50 drops slightly away from the second terminal support 34 in the up-down direction. I other words, the second magnet 50 is not fixed to the contact case 3. The second magnet 50 overlaps with the second fixed terminal 7 as viewed in the up-down direction. The second magnet 50 is disposed below the second fixed terminal 7.

The second magnet 50 includes a fifth magnetic surface 51, a sixth magnetic surface 52, a seventh magnetic surface 53, and an eighth magnetic surface 54. The fifth magnetic surface 51 faces in the front-rear direction. In the present embodiment, the fifth magnetic surface 51 is the front surface of the second magnet 50. The sixth magnetic surface 52 faces in the left-right direction. In this embodiment, the sixth magnetic surface 52 is the left surface of the second magnet 50. The seventh magnetic surface 53 faces in the up-down direction. In the present embodiment, the seventh magnetic surface 53 is the bottom surface of the second magnet 50. The eighth magnetic surface 54 faces in the front-rear direction. In the present embodiment, the eighth magnetic surface 54 is the rear surface of the second magnet 50.

The first yoke 60 is disposed around the contact case 3. The first yoke 60 is connected to the first magnet 40 and the second magnet 50. The first yoke 60 is disposed forward of the first magnet support 35 and the second magnet support 36. The first yoke 60 is formed of a single member. The first yoke 60 is positioned by the contact case 3. The first yoke 60 may be positioned by the case 2.

The first yoke 60 includes a first portion 61, a second portion 62, a third portion 63, a fourth portion 64, a fifth portion 65, a sixth portion 66, and a central portion 67.

The first portion 61 extends in a direction perpendicular to the front-rear direction. The first portion 61 extends rightward further from the right end of the central portion 67. The first portion 61 is disposed opposite to the first magnetic surface 41 of the first magnet 40. The first portion 61 is disposed in front of the first magnetic surface 41. The first portion 61 is attracted to the first magnetic surface 41. The first portion 61 is disposed in contact with the first magnetic surface 41.

The second portion 62 extends in a direction perpendicular to the left-right direction. The second portion 62 extends backward from the right end of the first portion 61. The second portion 62 is disposed opposite to the second magnetic surface 42 of the first magnet 40. The second portion 62 is disposed to the right of the second magnetic surface 42. The second portion 62 is attached to the second magnetic surface 42. The second portion 62 is disposed in contact with the second magnetic surface 42.

The third portion 63 extends in a direction perpendicular to the up-down direction. The third portion 63 extends leftward from the lower end of the second portion 62. The third portion 63 is disposed opposite to the third magnetic surface 43 of the first magnet 40. The third portion 63 is disposed below the third magnetic surface 43. The third portion 63 is attached to the third magnetic surface 43. The third portion 63 is disposed in contact with the third magnetic surface 43. The third portion 63 is separated from the first portion 61. The third portion 63 is connected to the first portion 61 via the second portion 62.

The dimension of the third portion 63 in the left-right direction is preferably at least one-fifth of the dimension of the third magnetic surface 43 of the first magnet 40 in the left-right direction. More preferably, the dimension of the third portion 63 in the left-right direction is at least one-third or at least one-half of the dimension of the third magnetic surface 43 of the first magnet 40 in the left-right direction. In the present embodiment, the dimension of the third portion 63 in the left-right direction is approximately the same as the dimension of the third magnetic surface 43 of the first magnet 40 in the left-right direction.

The fourth portion 64 has a shape symmetrical to the first portion 61. The fourth portion 64 is disposed opposite to the fifth magnetic surface 51 of the second magnet 50. The fourth portion 64 is attracted to the fifth magnetic surface 51. The fourth portion 64 is disposed in contact with the fifth magnetic surface 51.

The fifth portion 65 has a shape symmetrical to the second portion 62. The fifth portion 65 is disposed opposite to the sixth magnetic surface 52 of the second magnet 50. The fifth portion 65 is attracted to the sixth magnetic surface 52. The fifth portion 65 is disposed in contact with the sixth magnetic surface 52.

The sixth portion 66 has a shape symmetrical to the third portion 63. The sixth portion 66 is disposed opposite to the seventh magnetic surface 53 of the second magnet 50. The sixth portion 66 is attracted to the seventh magnetic surface 53. The sixth portion 66 is disposed in contact with the seventh magnetic surface 53. The dimension of the sixth portion 66 in the left-right direction is approximately the same as the dimension of the seventh magnetic surface 53 in the left-right direction.

The central portion 67 is disposed in front of the contact case 3. The central portion 67 extends in the left-right direction. The central portion 67 is disposed between the first portion 61 and the fourth portion 64. The right end of the central portion 67 is connected to the first portion 61. The left end of the central portion 67 is connected to the fourth portion 64. The central portion 67 is positioned in the up-down direction relative to the contact case 3 by a plurality of positioning protrusions 37 protruding from the front surface of the contact case 3. The plurality of positioning protrusions 37 are located on each of the upper case 31 and the lower case 32 of the contact case 3. The plurality of positioning protrusions 37 limit the movement of the first yoke 60 in the up-down direction.

The second yoke 70 has the same shape as the first yoke 60. The second yoke 70 has a shape front/rear symmetrical to the first yoke 60. The second yoke 70 is connected to the first magnet 40 and the second magnet 50. The second yoke 70 is disposed rearward of the first magnet support 35 and the second magnet support 36. The second yoke 70 includes a first portion 71, a second portion 72, a third portion 73, a fourth portion 74, a fifth portion 75, a sixth portion 76, and a central portion 77. A detailed description of the second yoke 70 is omitted.

In the electromagnetic relay 100 configured as described above, the magnetic force of the first magnet 40 acts on the first yoke 60 in the front-rear direction, the left-right direction, and the up-down direction. That is, the first yoke 60 is attracted to the first magnet 40 in three mutually orthogonal axial directions. This configuration allows the first yoke 60 to limit the upward movement of the first magnet 40 relative to the first yoke 60 in the three axial directions. Compared to the case where the first magnet 40 is fixed with a seal member, for example, the first magnet 40 moves less in the three axial directions with a simple configuration, and the manufacturing cost of the electromagnetic relay 100 is not increased.

For example, when an impact is applied to the electromagnetic relay 100 from below, the first magnet 40 is unlikely to adversely affect the members disposed around the first magnet 40 (e.g., the contact case 3 and the first fixed terminal 6) by moving upward. As a result, fewer malfunctions of the electromagnetic relay 100 occur.

Furthermore, the modified shape of the first yoke 60 (by adding a third portion 63 to the first yoke 60) can limit the movement of the first magnet 40 in the three axial directions, thereby maintaining the arrangement and size of the first magnet 40. As a result, the interruption performance for arcs can be preserved. It should be noted that in the present embodiment, the second yoke 70 can also restrict the movement of the first magnet 40 in the three axial directions. Similarly, the first yoke 60 and the second yoke 70 can limit the movement of the second magnet 50 in the three axial directions.

One embodiment of the electromagnetic relay according to one aspect of the claimed invention has been described above. The claimed invention, however, is not limited to the above embodiment, and various changes can be made without departing from the scope of the claimed invention.

The configuration of the contact case 3 may be changed. The contact case 3 may be formed by a single member. The configuration of the contact device 4 may be changed. For example, the first fixed terminal 6 and the second fixed terminal 7 may be cylindrical. The configuration of the drive device 5 may be changed. The drive device 5 may be configured to push the movable iron core 13 downward. In that case, the movable contact piece 8 is disposed above the first fixed terminal 6 and the second fixed terminal 7.

The first magnet 40 may be held only by the first yoke 60 and the second yoke 70. The first magnet support 35 and the second magnet support 36 may be omitted. The arrangement of the first magnet 40 may be changed. The claimed invention may be applied to an electromagnetic relay in which the first magnet 40 is disposed in front of or behind the contact case 3.

The configuration of the first yoke 60 may be changed, so long as it is attracted to the first magnet 40 in three axial directions. The first yoke 60 may be formed by a plurality of members. In that case, it is preferable that each of the members of the first yoke 60 is positioned by the contact case 3. For example, in the above embodiment, the second portion 62 may be a separate member from the first portion 61. That is, the second portion 62 may be separated from the first portion 61. Alternatively, the first portion 61, the second portion 62, and the third portion 63 may be separate members from one another. The third portion 63 may extend backward from the first portion 61. The second yoke 70 may be similarly changed in configuration to the first yoke 60.

The first portion 61 may be disposed apart from the first magnetic surface 41. The second portion 62 may be disposed apart from the second magnetic surface 42. The third portion 63 may be disposed apart from the third magnetic surface 43.

### REFERENCE NUMERALS

3: Contact case (Example of housing), 6: First fixed terminal, 6a: First fixed contact, 7: Second fixed terminal, 7a: Second fixed contact, 40: First magnet (Example of magnet), 41: First magnetic surface, 42: Second magnetic surface, 43: Third magnetic surface, 60: First yoke (Example of yoke), 61: First portion, 62: Second portion, 63: Third portion, 100: Electromagnetic relay

1. An electromagnetic relay, comprising:
a first fixed terminal including a first fixed contact;
a movable contact piece including a first movable contact disposed opposite to the first fixed contact;
a housing in which the first fixed contact and the movable contact piece are accommodated;
a magnet configured to generate a magnetic field inside the housing, the magnet including a first magnetic surface directed in a first direction, a second magnetic surface directed in a second direction perpendicular to the first direction, and a third magnetic surface directed in a third direction perpendicular to the first direction and the second direction; and
a yoke connected to the magnet, the yoke including a first portion, a second portion, and a third portion, wherein the first portion is disposed opposite to the first magnetic surface and is attracted to the first magnetic surface, the second portion is disposed opposite to the second magnetic surface and is attracted to the second magnetic surface, and the third portion is disposed opposite to the third magnetic surface and is attracted to the third magnetic surface.

2. The electromagnetic relay according to claim 1, wherein
the first fixed contact is disposed opposite to the first movable contact in the third direction, and
the third portion of the yoke is disposed in contact with the third magnetic surface.

3. The electromagnetic relay according to claim 2, wherein at least one of the first portion and the second portion of the yoke is disposed in contact with the magnet.

4. The electromagnetic relay according to claim 1, wherein
the first fixed contact is disposed opposite to the first movable contact in the third direction, and
the yoke is restricted from moving in the third direction relative to the housing.

5. The electromagnetic relay according to claim 1, wherein the third magnetic surface of the magnet is directed in a direction extending from the first fixed contact toward the first movable contact.

6. The electromagnetic relay according to claim 1, wherein the first fixed contact is disposed opposite to the first movable contact in the third direction, and the magnet overlaps the first fixed terminal as viewed from the third direction.

7. The electromagnetic relay according to claim 6, wherein the magnet is disposed between the first fixed terminal and the third portion of the yoke in the third direction.

8. The electromagnetic relay according to claim 1, further comprising a second fixed terminal including a second fixed contact, the second fixed terminal being disposed apart from the first fixed terminal in the second direction,
wherein the movable contact piece includes a second movable contact disposed opposite to the second fixed contact in the third direction, and
the third portion of the yoke has a dimension in the second direction that is one-fifth or more of the dimension of the third magnetic surface of the magnet in the second direction.
